(19) United States
(12) Patent Application Publication
(10) Pub. No.: US 2018/0016672 A1
(43) Pub. Date: Jan. 18, 2018

(54) METHOD OF CHROMIZING AN ARTICLE INCLUDING INTERNAL PASSAGES OF THE ARTICLE

(71) Applicant: United Technologies Corporation, Farmington, CT (US)

(72) Inventor: Michael N. Task, Vernon, CT (US)

(21) Appl. No.: 15/207,745

(22) Filed: Jul. 12, 2016

(51) Int. Cl. C23C 10/20; C23C 10/60; F01D 25/00; F01D 5/28; F01D 9/04

(52) U.S. Cl. CPC C23C 10/20; F01D 5/288; F01D 9/041; F01D 25/002; C23C 10/60; F05D 2260/95; F05D 2240/30; F05D 2230/90; F05D 2220/32; F05D 2300/132; F05D 2300/171; F05D 2300/175; F05D 2300/611; F05D 2240/12

(57) ABSTRACT

A method for chromizing an article includes applying a slurry to an article. The slurry has active chromium and a residue-removal agent. The method also includes heating the article and slurry to diffuse chromium from the slurry into the article. The heating leaves a residue on the article with the residue-removal agent. The heating also includes removing the residue-removal agent to thus remove the residue from the article, using a cleaning solution. A method for chromizing parts and a method of cleaning a chromized part are also disclosed.

### BACKGROUND

Articles that are subject to corrosion, such as gas turbine engine components, may include a coating to protect an underlying material from corrosion. Some articles have internal passages which are subject to corrosion and can be protected by such a coating.

Various techniques can be used to deposit a coating, such as “chromizing,” which results in a chromium-rich coating. Chromizing can be accomplished by, for instance, a vapor deposition process, or by the application of a slurry containing active chromium to the article and processing it.

### SUMMARY

A method for chromizing an article according to an example of the present disclosure includes applying a slurry to an article. The slurry has active chromium and a residue-removal agent. The method also includes heating the article and slurry to diffuse chromium from the slurry into the article. The heating leaves a residue on the article with the residue-removal agent. The heating also includes removing the residue-removal agent to thus remove the residue from the article, using a cleaning solution.

In a further embodiment of any of the foregoing embodiments, the article includes internal passages, and the residue is in the internal passages.

In a further embodiment of any of the foregoing embodiments, the slurry flows into the internal passages.

In a further embodiment of any of the foregoing embodiments, the amount of solids in the slurry is greater than about 25 percent by weight of the slurry.

The method of claim 2, wherein the amount of solids in the slurry is between about 50 and about 75 percent by weight of the slurry.

In a further embodiment of any of the foregoing embodiments, the residue-removal agent is inert with respect to the article and the slurry in the heating.

In a further embodiment of any of the foregoing embodiments, the residue-removal agent includes silica.

In a further embodiment of any of the foregoing embodiments, the residue-removal agent forms a matrix during the heating. The matrix traps the residue.

In a further embodiment of any of the foregoing embodiments, the slurry contains an amount of residue-removal agent sufficient to form a continuous matrix of residue-removal agent during the heating step.

In a further embodiment of any of the foregoing embodiments, the slurry contains an amount of solids, and greater than about 50% by weight of the solids of the residue removal agent.

In a further embodiment of any of the foregoing embodiments, the article is an airfoil.

A method for chromizing parts according to an example of the present disclosure includes applying a slurry to an article. The slurry has active metal and a residue-removal agent. The method also includes forming a matrix of the residue-removal agent and which residue in the matrix, and heating the article and the slurry. The heating diffuses the metal into the article to form a coating. The method also includes dissolving the matrix to remove the matrix and release the residue.

A further embodiment of any of the foregoing embodiments includes conducting the dissolving in a pressure chamber.

In a further embodiment of any of the foregoing embodiments, the dissolving includes cleaning the article with a hydroxide cleaning solution.

A method of cleaning a chromized part according to an example of the present disclosure includes cleaning a residue from a chromized article. The residue is trapped in a matrix of residue-removal agent on the chromized article. The cleaning is by dissolving the matrix to release the residue.

In a further embodiment of any of the foregoing embodiments, the article is cleaned with a hot pressurized cleaning solution in a pressure chamber.

In a further embodiment of any of the foregoing embodiments, the residue removal agent is soluble in the cleaning solution.

In a further embodiment of any of the foregoing embodiments, the cleaning solution is a hydroxide, and the residue-removal agent includes silica.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1A illustrates an example article.

FIG. 1B illustrates schematically illustrates a section view of the example article with internal passages.

FIG. 2 illustrates a method of chromizing the example article.

FIG. 3 illustrates the example article with chromizing residue and a chromium-enriched coating.

FIG. 4A illustrates the cleaned example article with a chromium-enriched coating.

FIG. 4B illustrates a section view of the cleaned example article with a chromium-enriched coating.

FIG. 5 illustrates a schematic detail view of a matrix formed by residue removal agent on the example article.

### DETAILED DESCRIPTION

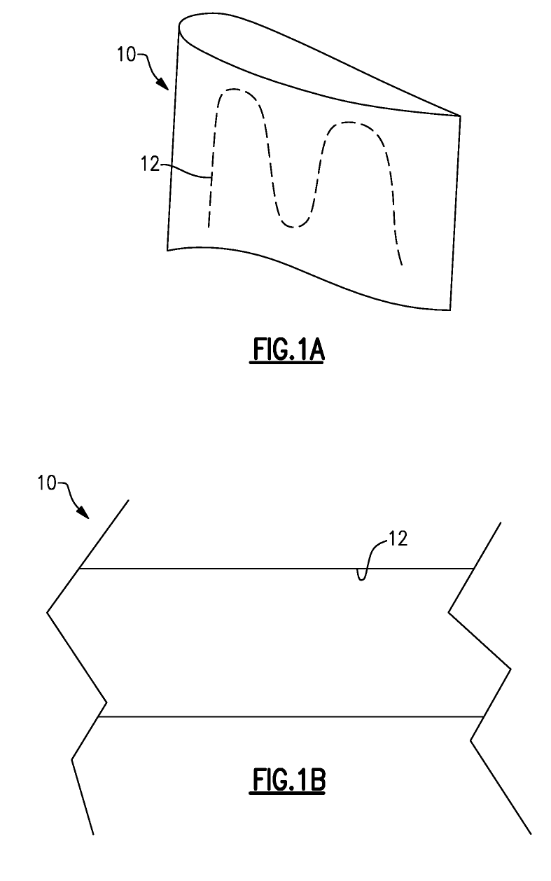

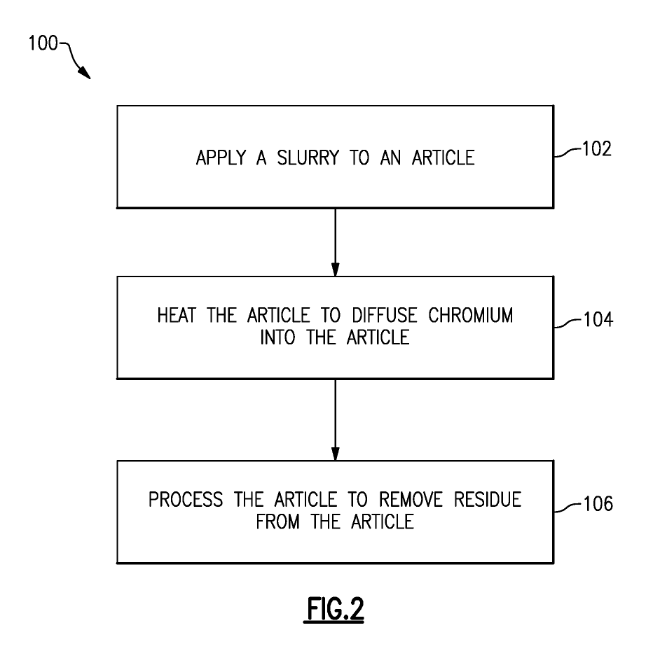

FIG. 1A illustrates an example article 10. In this example, the article 10 is an airfoil for a gas turbine engine. The article 10 may potentially be exposed to hot corrosion during the operation of the gas turbine engine, for example, up to temperatures of about 1900° F. (1038° C.). The article 10 may be formed of steel or a superalloy, such as a cobalt- or nickel-based superalloy. It should be understood, however, that this disclosure will benefit other articles or gas turbine engine components with internal passages. FIG. 1B illustrates a representative section view of the article 10 with internal passages 12.

FIG. 2 illustrates a method 100 of chromizing the article 10 including the internal passages 12. In Step 102, a slurry is applied at least to the internal passages 12. The slurry can be applied by, for example, dipping the article 10 into the slurry, spraying the slurry onto the article 10, painting the slurry onto the article 10, flowing the slurry across the article 10 and into internal passages 12, or by another method of application. Although some of the slurry may drip off, the slurry at least forms a slurry coating on surfaces of the internal passages 12.

The slurry contains an active coating metal of chromium powder in liquid carrier material. The slurry may also include alumina powder and/or a diffusion activator, such as chromium(III) chloride or a halide activator. The amount of liquid carrier material controls the viscosity of the slurry. The slurry contains enough liquid carrier material such that the slurry can readily flow through internal passages 12 of article 10. In one example, the amount of solids in the slurry is between about 50 and 75 percent by weight of the slurry. The slurry also includes residue-removal agent, such as silica, which is discussed in more detail below.

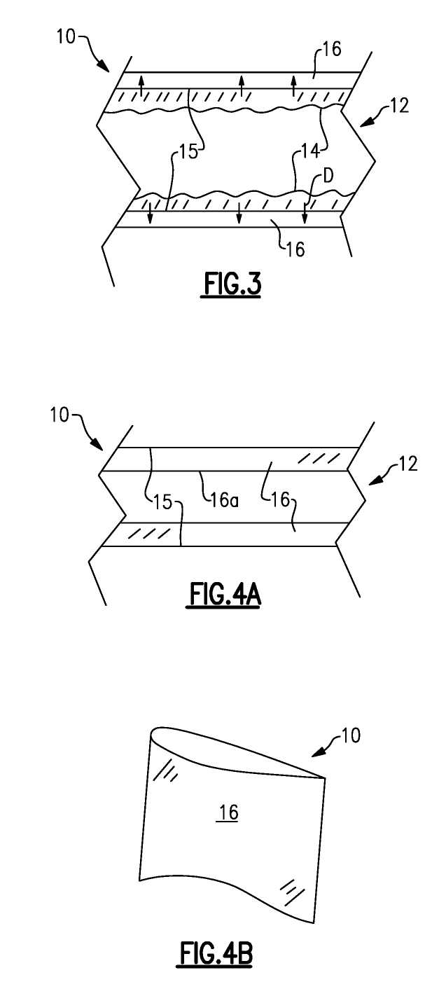

In Step 104, the article 10 with slurry coating is heated to diffuse chromium from the slurry coating into the article 10 as represented at D (FIG. 3, discussed in more detail below). In one example, the heating is conducted in a furnace having a continual flow of argon to produce an argon environment, in which argon is the most abundant gas, at a temperature greater than 1900° F. (103° C.), such as 1950° F. (1066° C.) to 2000° F. (1094° C.). The article 10 is heated for a selected amount of time, depending upon a desired thickness of the resulting chromium diffusion coating. In some examples, the selected amount of time is between 6 and 16 hours and the final chromium diffusion coating includes at least 20% by weight of chromium. The heating and diffusion creates a chromium-enriched coating 16, but leaves a residue or crust 14 on a surface 15 of the article 10 or internal passages 12, as shown in FIG. 3. For example, the coating 16 is the surface region of the article 10 that has diffused chromium.

In Step 106, the article 10 is processed to remove the residue 14 from the article 10, yielding an article 10 with the chromium-enriched coating 16 having a clean surface 16a, as is shown in FIGS. 4A-4B. For example, as will be discussed in more detail below, the processing includes cleaning the article with a cleaning solution. In other examples, the article may be processed in a different way, such as by grit blasting. The coating 16 can be on an outer surface of the article 16 and/or on the surfaces 15 of the internal passages 12, as shown in FIGS. 4A-B, respectively. In this example, the residue 14 is removed from the article 10 with a hot, pressurized cleaning solution. In one example, the cleaning solution is a hydroxide, and the processing step is performed inside a pressure chamber, such as an autoclave.

The residue removal agent permits removal of the residue 14. The residue removal agent is thermodynamically inert with respect to the slurry and the article 10. That is, the residue removal agent does not react or substantially react with the slurry or the article 10. In one example, the residue removal agent is or includes silica (silicon dioxide).

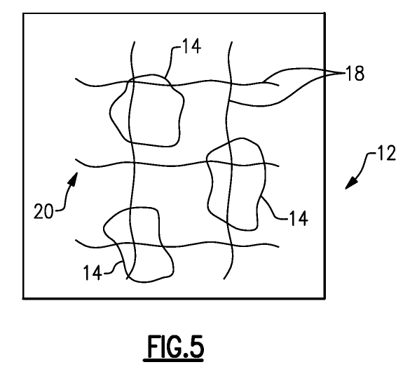

Turning to FIG. 5, the residue-removal agent 18 forms a matrix 20 on the surface 15 of the internal passage 12 during the heating step 104. Though the surface of the internal passage 12 is shown in FIG. 5, it should be understood that the residue removal agent 18 can form a matrix 20 on the exterior surface of the article 10 as well. For instance, the heating diffuses the chromium into the article 10 and evaporates the liquid carrier, leaving the silica to consolidate on the surface 15. The consolidated silica forms the matrix 20 and traps the residue 14. For example, the residue 14 may be residual constituents of the powders in the slurry, byproducts of the powders, or foreign substances.

The residue removal agent 18 is soluble in the cleaning solution. In one example, the residue 14 is insoluble or substantially insoluble in the cleaning solution. When the residue-removal agent 18 is dissolved by the cleaning solution, it releases the residue 14 from the article 10. This cleaning solution can flow through the internal passages 12 to contact the residue 14 in the internal passages 12 and thereby remove the residue 14. Other residue-removal methods, such as grit blasting or a similar mechanical process, can be difficult to perform in internal passages 12 or other non-line-of-sight surfaces of an article 10 because such methods require a clear physical line-of-sight to a surface for effective removal.

In one example, the slurry contains an amount of residue removal agent 18 sufficient to form the matrix 20. In a further example, the slurry contains an amount of residue removal agent 18 sufficient to form a continuous matrix 20. That is, the continuous matrix 20 entraps all the residue 14 from the heating and diffusion, and when the matrix 20 is removed from the article 10 by the processing step 106, substantially all of the residue 14 is removed with it. Although less residue removal agent 18 could be used, lower amounts increase the potential for residue 14 to bond to the surface 15 of the internal passage 12 or to the article 10, thereby making removal more difficult. In a yet another example, the slurry contains greater than about 25% by weight of solids of residue removal agent 18. More particularly, the slurry contains greater than about 50% by weight of solids of residue removal agent 18.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A method for chromizing an article, the method comprising:
applying a slurry to an article, the slurry including active chromium and a residue-removal agent;
heating the article and slurry to diffuse chromium from the slurry into the article, the heating leaving a residue on the article with the residue-removal agent; and
removing the residue-removal agent, to thus remove the residue from the article, using a cleaning solution.

2. The method of claim 1, wherein the article includes internal passages, and the residue is in the internal passages.

3. The method of claim 2, wherein the slurry flows into the internal passages.

4. The method of claim 2, wherein the amount of solids in the slurry is greater than about 25 percent by weight of the slurry.

5. The method of claim 2, wherein the amount of solids in the slurry is between about 50 and about 75 percent by weight of the slurry.

6. The method of claim 1, wherein the residue-removal agent is inert with respect to the article and the slurry in the heating.

7. The method of claim 1, wherein the residue-removal agent includes silica.

8. The method of claim 1, wherein the residue-removal agent forms a matrix during the heating, the matrix trapping the residue.

9. The method of claim 8, wherein the slurry contains an amount of residue-removal agent sufficient to form a continuous matrix of residue-removal agent during the heating step.

10. The method of claim 9, wherein the slurry contains an amount of solids, and greater than about 50% by weight of the solids of the residue removal agent.

11. The method of claim 1, wherein the article is an airfoil.

12. A method for chromizing parts, the method comprising:
applying a slurry to an article, the slurry including active metal and a residue-removal agent;
forming a matrix of the residue-removal agent and trapping residue in the matrix by heating the article and the slurry, the heating also diffusing the metal into the article to form a coating; and
dissolving the matrix to remove the matrix and release the residue.

13. The method of claim 12, including conducting the dissolving in a pressure chamber.

14. The method of claim 12, wherein the dissolving includes cleaning the article with a hydroxide cleaning solution.

15. A method of cleaning a chromized part, the method comprising:
cleaning a residue from a chromized article, the residue being trapped in a matrix of residue-removal agent on the chromized article, by dissolving the matrix to release the residue.

16. The method of claim 15, wherein the article is cleaned with a hot pressurized cleaning solution in a pressure chamber.

17. The method of claim 16, wherein the residue removal agent is soluble in the cleaning solution.

18. The method of claim 17, wherein the cleaning solution is a hydroxide, and the residue-removal agent includes silica.
